(19) United States
(12) Patent Application Publication
(10) Pub. No.: US 2016/0262348 A1
(43) Pub. Date: Sep. 15, 2016

(54) Alpha Sheath Shield

(71) Applicants: Ashley Ann McClure, Plantation, FL (US); Judy Ann McClure, Plantation, FL (US); Michelle Kathryn Marotta, Plantation, FL (US)

(72) Inventors: Ashley Ann McClure, Plantation, FL (US); Judy Ann McClure, Plantation, FL (US); Michelle Kathryn Marotta, Plantation, FL (US)

(21) Appl. No.: 15/158,467

(22) Filed: May 18, 2016

(51) Int. Cl. A01K 13/00

(52) U.S. Cl. CPC A01K 13/006

(57) ABSTRACT

The Alpha Sheath Shield serves the purpose of keeping flies and insects away from a horse's sheath (penile area) to help heal from Florida sores, summer sores, or any sores and infections in that area. The shield also can be used to prevent Florida sores, summer sores, or any other sores from forming in current wounds. The shield is composed of a mesh material to allow urine to pass freely while not allowing insects inside to aggravate penile wounds.

### BACKGROUND

1. Field of the Invention

The present invention relates to a livestock medical apparatus. More particularly, the invention relates to an equestrian related product that serves as a shield to keep flies and insects away from a horse's sheath (penile area) to help heal or prevent Florida sores, summer sores, or any sores and infections in that area.

2. Description of the Related Art

A summer sore is a common skin problem in horses in which a parasite carried by the typical housefly or stable fly causes swelling, ulceration, redness, itching, or a lesion of exuberant granulation tissue. The lesions can occur anywhere, but the most common areas are the legs, lips, around the eyes, abdomen, and the genital area of geldings and stallions—which is one of the hardest areas to treat.

About 8 years ago, one of our miniature ponies, Prankster, was diagnosed with a Florida sore in the penile area. I had received a call from a friend of mine who said that Prankster was badly injured, and that it looked like a chink of his penis was missing. I immediately called our vet to relay the message. I soon arrived at the barn to see the mini's sheath out, and a bloody sore located at the tip. We were all very concerned because it could very well be cancer. The vet took a sample of the sore and then injected it with a dewormer and medication. We watched, as Prankster slowly progressed over a few weeks. As time went by, the swelling and the sore slowly went down. It appeared the Florida sore was defeated, and that Prankster could be himself again. A few more weeks went by when I noticed his sheath had dropped again. I inspected it and found yet again, our archenemy was back. I called the vet and we gave him another dewormer shot and applied cream twice a day to the infected area, but this time around, the Florida sore failed to go away. It progressively got worse and was spreading up the sheath. We were all concerned and took another biopsy in fear that it could be cancer. The test results took longer than normal to get back and concern for Prankster was rising. The vet had told me that the reason a Florida sore is created is due to flies laying eggs into an open cut, causing a painful sore. Since we could not wrap the area, it was hard to flies away, and I knew that if we could not keep the flies away, it would worsen. I attempted to keep them away with fly creams and sprays, but no avail. Finally, I resorted to a plastic Ziploc bag with holes in it to wrap around Prankster's penis. To my surprise the device was actually working to keep the flies out. Unfortunately, Prankster soon broke the bag while rolling in the dirt, his favorite past time. I knew that I would have to make some adjustments to my brainchild. Meanwhile, the vet called and said that if only we could mosquito net the whole stall, Prankster would improve. However, that suggestion would be nearly impossible, and extremely costly. Suddenly, an idea sparked in my head and I soon got to work on the “Alpha Sheath Shield”. Hours went by but I finally came up with my first design. I tried it on Prankster and it was working . . . no flies!! When the vet came back to check on Pranksters progress, he thought the Alpha Sheath Shield was brilliant and gave me some of his own suggestions for further comfort for the horse.

Since the use of the Alpha Sheath Shield, Prankster had progressed extremely. Quickly, the Alpha Sheath Shield provided the protection form the flies that he needed while he was healing. Sometimes Florida sores may never heal due to these pesky flies, but our beloved Prankster did, thanks to the Alpha Sheath Shield. I have already helped numerous horses with the same ailments and would love to continue to help those in need.

The purpose to the Sheath Shield is to minimize the amount of flies irritating the horses sheath (pouch that contains the horses penis). Wounds do appear in this area which make the healing process very difficult since flies are so attracted to the area. Wounds or sores such as Florida Sores are very difficult to get rid of because of the flies laying eggs and creating a bigger sore. Without proper treatment, this sore can continually grow when irritated by flies. That is why I have invented this product, which has helped out one of my horses who had this very problem, and another horse with the same problem. I would wish to help many others who have this issue because it does work.

### BRIEF DESCRIPTION OF THE DRAWINGS

The above and other aspects, features and advantages of certain exemplary embodiments of the present invention will be more apparent for the following description taken in conjunction with the accompanying drawings, in which:

FIG. 1 is a schematic drawing illustrating the components of the Alpha Sheath Shield medical apparatus.

FIG. 2 is a photograph of the Alpha Sheath Shield on a horse model to demonstrate how the apparatus fits onto the horse.

FIG. 3 is a photograph of the Alpha Sheath Shield illustrating how the shield looks.

### DETAILED DESCRIPTION OF EXEMPLARY EMBODIMENTS

The following description with reference to the accompanying drawings is provided to assist in the comprehensive understanding of exemplary embodiments of the present invention as defined by the claims and their equivalents. It includes various specific details to assist in the understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

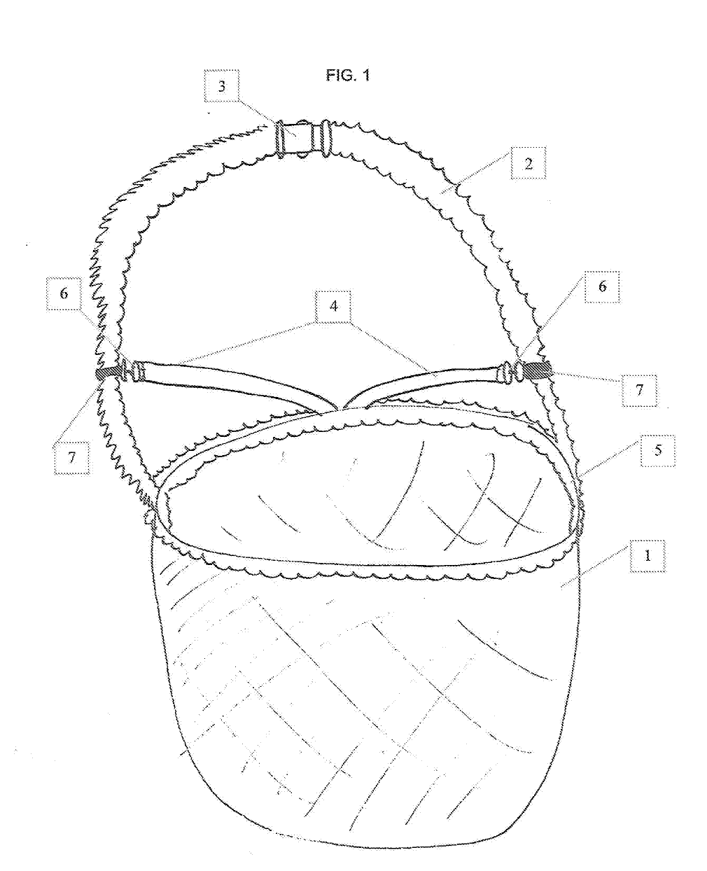

As mentioned previously, the Alpha Sheath Shield serves the purpose of keeping flies and insects away from the horse's sheath (penile area) to help heal from Florida sores, summer sores, or any sores and infections in that area or to prevent Florida sores, summer sores, or any other sores from forming in current wounds. FIG. 1 displays the mesh bag-like design (1) made of beige UV-protective plastic-like mesh fabric that allows urine can pass right through. The mesh fabric is formed into a bag and sewn in that shape with clear heavy-weight fishing line. Then it attaches to a ½ inch clear plastic tubing ring (5), giving the bag support and acting as an attachment point for the strapping. Holding the mesh bag in place on the plastic tubing is glue and twine. The twine is wrapped around the tubing and sewn through the plastic mesh. Also attached to the plastic tubing are two black cotton-polyester straps (2) on each side of the bag that wrap around the horses back to hold the bag in place. The straps are sewn around the plastic tubing using dark blue thread and are attached together at the top with a black plastic parachute buckle (3). The parachute buckle allows the straps to be adjustable and makes the Alpha Sheath Shield easy to take off and clean.

Toward the back side of the plastic ring is where the two black elastic straps (4) are attached. They too are sewn through the plastic mesh and are sewn around the plastic tubing ring. At the other end of the elastic straps is a silver buckle (6) that attaches to its other half located on the cotton black straps (7). The elastic straps are used to hold the sheath Shield in place by going through the horses legs so the shield cannot slip. The elastic straps are also adjustable via a silver “vest buckle” that is attached to the elastic strap with the silver buckle.

Sheepskin is added for additional comfort and is sewn with white thread around the black cotton-polyester straps (2), and around the plastic tubing (5) to keep the mesh and twine from irritating and rubbing on the horses skin. Due to the sudden resistance to ivermectin treatment, the battle between flies and the sore/infection is even more challenging. The Alpha Sheath Shield is a cost effective way of eliminating the flies or insect around the penile area to help aid in the healing process.

What is claimed is:

1. An Alpha Sheath Shield comprising:
a plastic mesh material, ¾ inch plastic tubing, two 1 inch wide cotton belting straps, two ¾ inch wide braided elastic straps, one parachute buckle, two nickel 1.75 inch by 1.75 inch fashion toggle buckles, two ¾ inch vest buckles, and sheepskin (Sherpa fur) fabric.

2. The invention of claim 1 wherein the plastic tubing is glued to the superior aspect of one side of the plastic mesh material. The plastic mesh material and plastic tubing are glued and sewn into the shape of a bag with the superior aspect of the bag containing the plastic tubing is open. The plastic tubing creates a rigid structure and support to attach the straps to the bag.

3. The invention of claim 2 wherein the cotton belting straps are attached to the mesh bag opposite of each other at the superior aspect of the opening of the mesh bag.

4. The invention of claim 2 herein the two braided elastic straps are attached to the superior aspect of the opening of the mesh bag adjacent to the 1 inch wide cotton belting straps

5. The invention of claim 3 wherein the parachute buckle is attached to the free ends of both the 1 inch wide cotton belting straps.

6. The invention of claim 4 wherein the one half of the nickel 1.75 inch by 1.75 inch fashion toggle buckle is attached to the free end of each braided elastic straps via the ¾ inch vest buckles.

7. The invention of claim 6 wherein the other half of the nickel 1.75 inch by 1.75 inch fashion toggle buckle is attached to the cotton belting straps via a small strip of braided elastic sewn into a circle.

8. The invention of claim 7 wherein the other half of the nickel 1.75 inch by 1.75 inch fashion toggle buckle is sewn onto a small strip of braided elastic sewn into the shape of a circle is threaded onto each of the cotton belting straps.

9. The invention of claim 8 wherein the two halves of the nickel 1.75 inch by 1.75 inch fashion toggle buckle are connected together to attach the cotton belting straps to the braided elastic straps.

10. The invention of claim 2 wherein Sherpa fur is sewn along the of the mesh bag along the circular shape of the plastic tubing for added comfort.

11. The invention of claim 3 wherein Sherpa fur is sewn along both the cotton, belting straps for extra comfort.

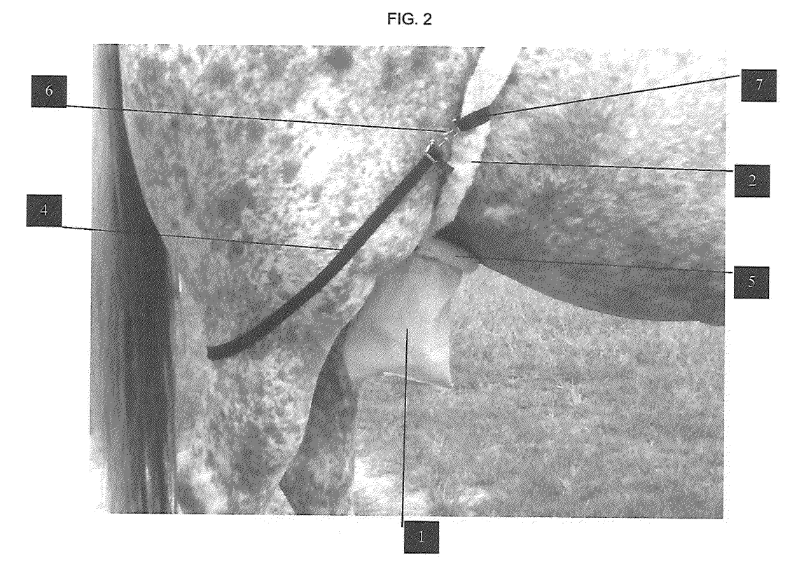

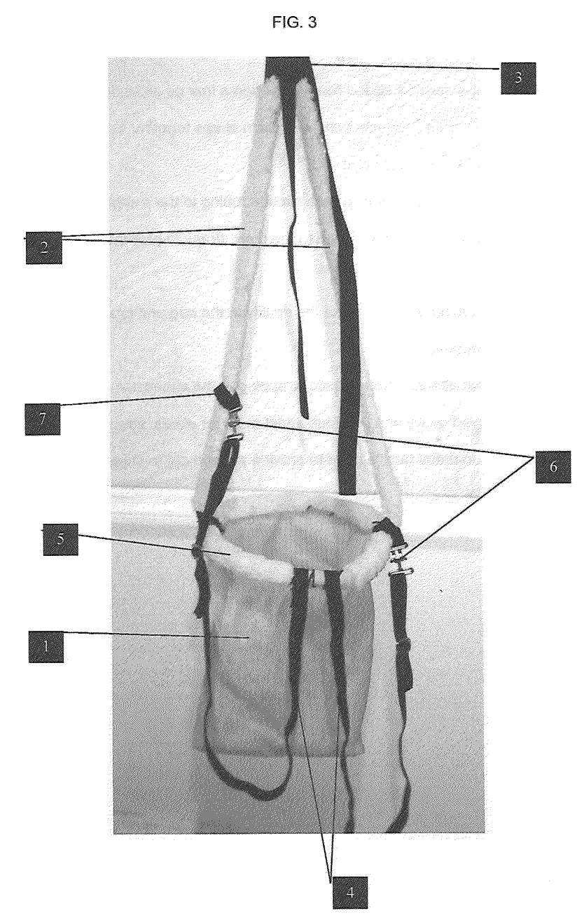

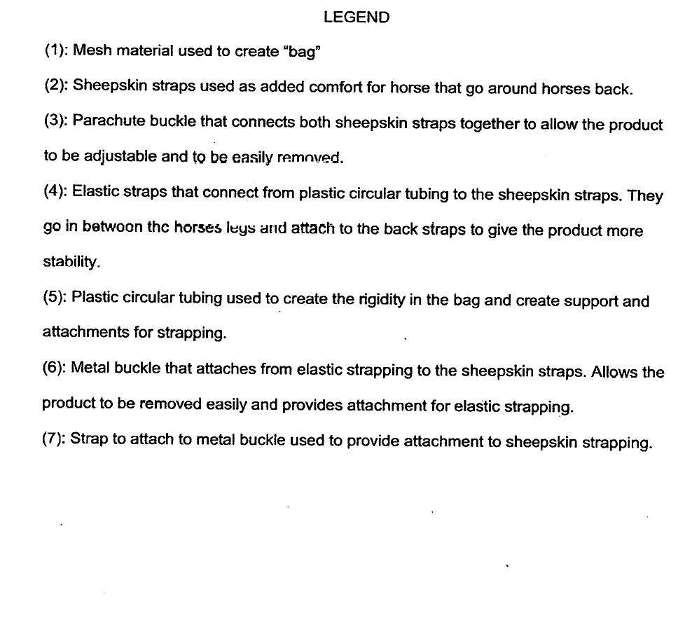

12. The ornamental design for the Alpha Sheath Shield as shown in FIG. 1-3.
